(19) United States
(12) Patent Application Publication
(10) Pub. No.: US 2011/0088507 A1
(43) Pub. Date: Apr. 21, 2011

(54) Systems and Methods for Powering a Variable Load with a MultiStage Flywheel Motor

(76) Inventor: Zane C. Fields, Bothell, WA (US)

(21) Appl. No.: 12/980,114

(22) Filed: Dec. 28, 2010

Related U.S. Application Data
(63) Continuation-in-part of application No. 12/168,105, filed on Sep. 22, 2008.

(51) Int. Cl. B60K 6/10; F16C 15/00

(52) U.S. Cl. 74/572.1

(57) ABSTRACT

A multi-rotor flywheel motor system for powering a vehicle. The flywheel motor system includes at least the following components: a plurality of flywheel rotors, a housing assembly, an energy input mechanism for each of the flywheel rotors, a plurality of pressure plates, and a crankshaft. The flywheel rotors are configured such that they may be frictionally coupled or decoupled and powered or non-powered in various combinations. In this regard, the flywheel motor system is able to efficiently meet the power demands of a vehicle in a range of operating conditions.

### CROSS REFERENCE TO RELATED APPLICATIONS

This application is a continuation-in-part of U.S. patent application Ser. No. 12/168,105, filed Sep. 28, 2008, now pending, which is incorporated by reference in its entirety.

### FIELD OF THE INVENTION

The field of the present invention generally relates to systems and methods associated with the utilization of a multi-stage flywheel motor. Specifically, the invention relates to a flywheel motor adapted with one or more auxiliary rotors that can be coupled with or decoupled from a primary flywheel rotor in order to optimally meet the changing power demands of a variable load, such as a load associated with a motor vehicle.

### BACKGROUND OF THE INVENTION

In the field of zero-emission motor design, it is desirable to utilize flywheel energy storage devices that operate by accelerating a flywheel rotor to a desired angular velocity, thus increasing the kinetic energy of the flywheel rotor and the available energy stored within the flywheel motor for subsequent use by a variable load, such as a vehicle. As would be familiar to those skilled in the Art, some flywheel devices are currently being utilized in “regenerative braking” technologies, which generally involve the storage of a vehicle's recovered kinetic energy. Energy stored in the flywheel can subsequently be used to propel the vehicle in a preferred direction or to power an electric generator long enough to charge a resident electric power source, such as a super capacitor or a battery array.

Flywheels are particularly well suited for such tasks because they are capable of being accelerated to a high angular velocity in a relatively short period of time. Likewise, flywheels are capable of being quickly decelerated in order to rapidly discharge their stored energy. In other words, a flywheel can go from storing no energy, to storing a massive amount of energy, and back down to storing no energy, in a relatively short period of time as compared to other storage technologies, such as batteries, which generally take much longer to charge and discharge. Flywheel motors are an attractive option as a vehicle powerplant (e.g., an automobile motor), because of their ability to store and deliver energy rapidly. These vehicles generally require a large amount of power for a variable duration when accelerating quickly, climbing a hill, traversing rugged terrain, or the like.

Attempts have been made to create flywheel motors by coupling a single-stage flywheel mechanism with a drive that is capable of slowly and continuously adding energy to the flywheel in a relatively simple arrangement. For example, previous designs have utilized small electric motors as an energy input device to accelerate the flywheel. In this regard, the flywheel acts as an energy reservoir capable of meeting the peak power demands of a vehicle whereas the small electric motor or other energy input mechanism, by itself, would not be capable of providing the peak power necessary to adequately propel a vehicle. Unfortunately, these single-stage flywheel motors are often unable to provide sustained power output when needed, such as in situations where a vehicle is towing a trailer, carrying large load, traveling on and incline or at high rate of speed, etc. In these taxing scenarios, existing flywheel motors often fail under sustained operation if the vehicle's demand for power is greater than the power being provided by the small electric motor or other energy input mechanism.

Attempted remedies for this sustainability problem have generally involved increasing the capacity of the single-stage flywheel to allow it to store more energy. In other words, increasing the energy storage capacity of the flywheel to the extent necessary in order to make up for the net outflow of energy during the period of time where the vehicle operating conditions demand more power than that provided by the energy input mechanism.

One method for increasing the energy capacity of a flywheel has been to increase the moment of inertia of the flywheel rotor. As would be understood by those skilled in the Art, “moment of inertia” is generally defined as a measure of the resistance of a body to angular acceleration about a given axis that is equal to the sum of the products of each element of mass in the body and the square of the element's distance from the axis. A principle method of increasing the moment of inertia is to increase the radius of the flywheel, which may be impractical given space constraints aboard vehicles. Another method of increasing the energy capacity of a flywheel has been to increase the flywheel's angular velocity by placing the flywheel in an enclosed environment that minimized friction and drag.

Recent research efforts have largely focused on reducing friction within a motor to facilitate increased flywheel rotor angular velocities. Unfortunately, extremely high angular velocities create an increased risk of catastrophic rotor burst. Catastrophic rotor burst occurs when centripetal forces exceed the structural capabilities of the flywheel rotor and it is often described as being similar to the explosion of a bomb. Pieces of the flywheel rotor can be sent flying at very high speeds, in primarily radial directions. The problem associated with catastrophic rotor burst is compounded aboard vehicles, which are susceptible to collisions that could trigger a catastrophic rotor burst. Aside from obvious safety concerns, technologies used to facilitate extremely high rotational velocities, such as vacuums, magnetic levitation, and advanced materials technology, may be cost-prohibitive for mass production and/or widespread usage.

Another common method of increasing energy storage capacity of a flywheel has been to increase the mass of the flywheel rotor within a single-stage arrangement. This method shares many of the same deficiencies associated with other attempted solutions, mentioned above. Increasing the mass of a flywheel rotor often will increase the size and weight of the rotor and this may be impractical given large start-up torque requirements, as well as space, weight, installation, and maintenance considerations aboard vehicles. Moreover, if a rotor with an increased mass were to experience a catastrophic rotor burst, the burst would be more destructive than a similar failure of a flywheel rotor having lesser mass.

Another solution to the problem has been to increase the size and power of the small electric motor or other energy input mechanism such that the energy input mechanism is capable of providing enough energy to prevent failure during prolonged peak power operating conditions of the vehicle. However, switching to an energy input mechanism with greater power typically negatively impacts the economy and efficiency of the flywheel motor system, since it requires more power to operate. Moreover, it may be impractical to have both a larger electric motor and a flywheel aboard a vehicle given space, weight and other considerations.

Thus, there exists a need for an efficient, safe, compact, relatively inexpensive to manufacture, multi-stage flywheel motor that is capable of storing increased amounts of energy while operating within a desirable range of angular velocities.

### SUMMARY OF THE INVENTION

This summary is provided to introduce (in a simplified form) a selection of concepts that are further described below in the Detailed Description. This summary is not intended to identify key features of the claimed subject matter, nor is it intended to be used as an aid in determining the scope of the claimed subject matter.

In overcoming the above disadvantages associated with modern flywheel motor systems and methods associated with operating these single-stage motors, the present invention discloses a flywheel motor configured to have a variable moment of inertia, the flywheel motor includes a housing assembly, a plurality of flywheels, each flywheel adapted to be driven by at least one tangential force, a plurality of pressure plates affixed to exterior portions of the plurality of flywheels, a crankshaft connected to a primary flywheel, a secondary flywheel movably paired to the crankshaft with a first bearing, and a first pressure chamber adapted to frictionally couple the primary and secondary flywheels by engaging at least one pressure plate affixed to the primary flywheel and at least one pressure plate affixed to the secondary flywheel with a first intermediary friction disc.

In accordance with one aspect of the present invention, the plurality of flywheels each have one or more permanent magnets, and the housing assembly is coupled to a stator assembly that is configured to drive the flywheel with an electromagnetic tangential force.

In accordance with another aspect of the present invention, the housing assembly is coupled to a fluid jet assembly that is configured to drive the flywheel with a tangential fluid force.

In accordance with yet another aspect of the present invention, the flywheel motor includes a tertiary flywheel movably paired to the crankshaft with a second bearing, and a second pressure chamber adapted to frictionally couple the primary and tertiary flywheels by engaging one or more pressure plates affixed to the primary flywheel and one or more pressure plates affixed to the secondary flywheel with a second intermediary friction disc.

In accordance with a further aspect of the present invention, the primary, secondary, and tertiary flywheels have substantially the same diameter but different moment of inertias.

In accordance with another aspect of the present invention, the primary, secondary, and tertiary flywheels have substantially the same diameter and moment of inertias.

In accordance with yet another aspect of the present invention, is a multi-rotor flywheel energy storage system for vehicles that includes a primary flywheel assembly with a means for applying a tangential force to a primary rotor, a secondary flywheel assembly with a means for applying a tangential force to a secondary rotor, a tertiary flywheel assembly with a means for applying a tangential force to a tertiary rotor, a driveshaft that is fixedly coupled to the primary rotor and rotatably coupled to the secondary and the tertiary rotors, a first thrust mechanism configured to frictionally engage the secondary rotor with the primary rotor when the first thrust mechanism is activated or to frictionally disengage the secondary rotor from the primary rotor when the first thrust mechanism is deactivated, and a second thrust mechanism configured to frictionally engage the tertiary rotor with the primary rotor when the second thrust mechanism is activated or to frictionally disengage the tertiary rotor from the primary rotor when the second thrust mechanism is deactivated.

In accordance with a further aspect of the present invention, the multi-rotor flywheel energy storage system further includes a base portion, a top containment ring portion, a bottom containment ring portion, and first and second end plates configured to rotatably engage the driveshaft.

In accordance with another aspect of the present invention, the secondary rotor and the tertiary rotor are adapted to frictionally engage with the primary rotor with a plurality of pressure plates and at least one friction disc.

In accordance with yet another aspect of the present invention, the means for applying tangential force to the primary, secondary, and tertiary rotors is a plurality of electromagnets configured to apply a repulsive magnetic force to permanent magnets of the primary, secondary, and tertiary rotors.

In accordance with a further aspect of the present invention, the means for applying tangential force to the primary, secondary, tertiary rotors is at least one fluid jet configured to drive turbine blades of the primary, secondary, and tertiary rotors.

In accordance with another aspect of the present invention, the primary, secondary, and tertiary rotors have substantially the same diameter but different moment of inertias.

In accordance with yet another aspect of the present invention, the primary, secondary, and tertiary rotors have substantially the same diameter and moment of inertias.

In accordance of a further aspect of the present invention, is a method of storing energy in a multi-rotor flywheel system that includes adding rotational energy to a primary rotor affixed to a driveshaft by applying a tangential force to the primary rotor, adding rotational energy to a secondary rotor rotatably coupled to the driveshaft by applying a tangential force to the secondary rotor; and activating a first thrust mechanism to frictionally engage the secondary rotor with the primary rotor, such that the primary and secondary rotors couple to increase the moment of inertia applied to the driveshaft.

In accordance with another aspect of the present invention, the method of storing energy in a multi-rotor flywheel system further includes adding rotational energy to a tertiary rotor that is rotatably coupled to the driveshaft by applying a tangential force to the tertiary rotor, and activating a second thrust mechanism to frictionally engage the tertiary rotor with the primary rotor such that the primary, secondary, and tertiary rotors couple to increase the moment of inertia affixed to the driveshaft.

In accordance with yet another aspect of the present invention, the method of storing energy in a multi-rotor flywheel system further includes removing rotational energy from the primary, secondary, and tertiary rotors by applying a torque to the driveshaft.

In accordance with a further aspect of the present invention, the tangential forces applied to the primary, secondary, and tertiary rotors emanate from a plurality of electromagnets configured to apply a repulsive magnetic force to permanent magnets of the primary, secondary, and tertiary rotors.

In accordance with another aspect of the present invention, the tangential forces applied to the primary, secondary, and tertiary rotors emanate from at least one fluid jet configured to drive turbine blades of the primary, secondary, and tertiary rotors.

In accordance with yet another aspect of the present invention, the primary, secondary, and tertiary rotors have substantially the same diameter but different moment of inertias.

In accordance with a further aspect of the present invention, the primary, secondary, and tertiary rotors have substantially the same diameter and moment of inertias.

### BRIEF DESCRIPTION OF THE DRAWINGS

Preferred and alternative examples of the present invention are described in detail below by way of example and with reference to the drawings, in which:

FIG. 1 is an environmental view of a multi-stage flywheel motor assembly mounted within an automobile, in accordance with an embodiment of the present invention;

FIG. 2 is an isometric cutaway view of the flywheel motor assembly associated with FIG. 1, in accordance with an embodiment of the present invention;

FIG. 3 is a front planar view of the flywheel motor assembly associated with FIG. 1, in accordance with an embodiment of the present invention;

FIG. 4 is a side planar view of the flywheel motor assembly associated with FIG. 1, in accordance with an embodiment of the present invention;

FIG. 5 is a side planar cutaway view of the flywheel motor assembly associated with FIG. 1, in accordance with an embodiment of the present invention;

FIG. 6 is a side planar view of a primary flywheel rotor component of a multi-stage flywheel motor assembly, in accordance with an embodiment of the present invention;

FIG. 7 is a front planar cutaway view of a primary flywheel rotor component associated with FIG. 6, in accordance with an embodiment of the present invention;

FIG. 8 is a side planar view of a secondary flywheel rotor component of a multi-stage flywheel motor assembly, in accordance with an embodiment of the present invention;

FIG. 9 is a front planar cutaway view of an auxiliary flywheel rotor component (e.g., a secondary or tertiary flywheel rotor) associated with FIG. 9, in accordance with an embodiment of the present invention; and

FIG. 10 is a side planar cutaway view of a multi-stage flywheel motor assembly, in accordance with an embodiment of the present invention.

### DETAILED DESCRIPTION

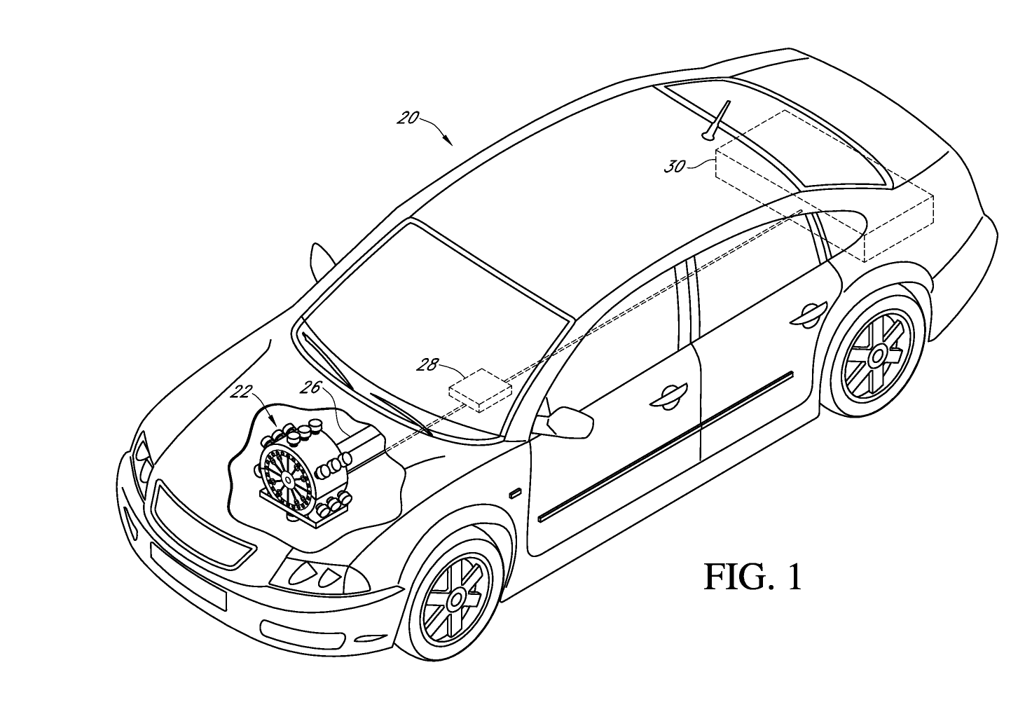

In accordance with an exemplary embodiment of the present invention, FIG. 1 depicts a multi-stage flywheel motor assembly 22 (also referred to herein as a “flywheel motor assembly” or a “flywheel motor”) mounted in the front engine compartment of an automotive vehicle 20. The flywheel motor assembly 22 may be mounted within the confines of a vehicle 20 in any manner well known in the Art (e.g., such as with vibration-isolating mounts), without departing from the spirit and scope of the present invention.

A power source 30 may be connected to the flywheel motor assembly 22 via a controller 28. The power source 30 is preferably a battery array, but may also be a super capacitor, fuel cell, generator, or the like. Alternatively, the power source 30 may provide non-electrical power such as a hydraulic or pneumatic power to drive the flywheel motor 22. In accordance with various embodiments, the controller 28 may manage, convert, distribute and/or condition energy emanating from the power source 30 into a form that is optimized to drive the flywheel rotors of the multi-stage flywheel motor 22. It would be readily understood by a person having ordinary skill in the Art that the controller 28, shown in FIG. 1, may be a separate piece of equipment, or it may be optionally integrated as part of either the power source 30 or the flywheel motor assembly 22, without departing from the spirit and scope of the present invention.

In an embodiment, the flywheel motor assembly 22 may be a brushless direct current motor (BLDC) and the controller 28 may be an electric speed controller including power transistor logic circuitry for synchronously driving the different phases (e.g., pairs of opposing stator coil poles) of the flywheel motor 22. As would be understood by those skilled in the Art, BLDC motors offer several advantages over brushed DC motors, including more torque per weight, improved efficiency and reliability, reduced noise, longer lifetime, improved power output, and overall reduction of electromagnetic interference (EMI). Further, BLDC motors can be cooled by conduction, requiring no airflow within the motor housing for cooling. This allows for the motor's rotor(s) and drive components to be entirely enclosed and protected from dirt or other foreign matter.

The flywheel motor assembly 22 of FIG. 1 also includes a driveshaft 26 (interchangeably referred to herein as a crankshaft, axle, rod, or rotatable member), that is attached to the flywheel motor assembly 22. The driveshaft 26 is adapted to transmit rotational energy from the flywheel motor assembly 22 to the drive wheels of the vehicle 20. Although the driveshaft 26 can connect the flywheel motor assembly 22 to the drive wheels of the vehicle 20, it should be understood that the driveshaft 26 may also be coupled with a clutch, gears, differential(s), and the like, in order to deliver power to the drive wheels. Collectively these drive components (including the flywheel motor 22) make up the power train of the vehicle 20.

Although the embodiment illustrated in FIG. 1 is described herein as being used to power an automotive vehicle 20, it should be apparent to one skilled in the Art that the flywheel motor assembly 22 has wide application and is suitable for use wherever it is desirable to have sustained rotational power provided to a particular load. In an embodiment, the flywheel motor assembly 22 may also be used in any other type of vehicle such as a motorcycle, tricycle, locomotive, boat, or airplane without departing from the spirit and scope of the present invention. In an embodiment, the flywheel motor assembly 22 may simultaneously provide rotational power to vehicle subsystems such as a generator or a pump.

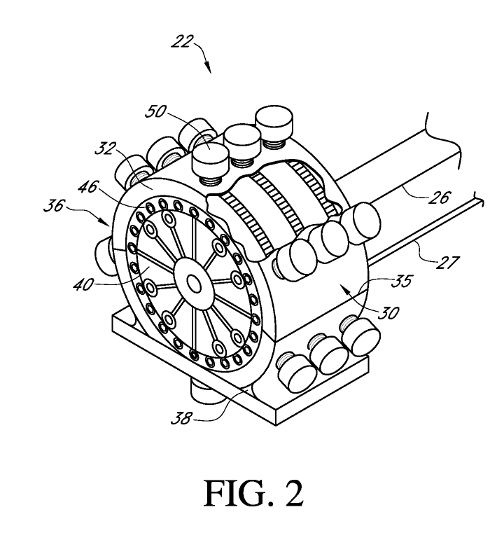

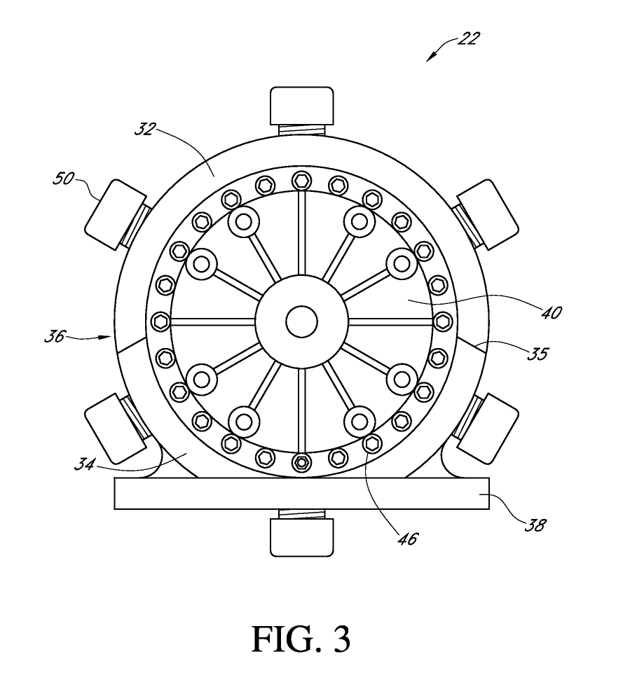

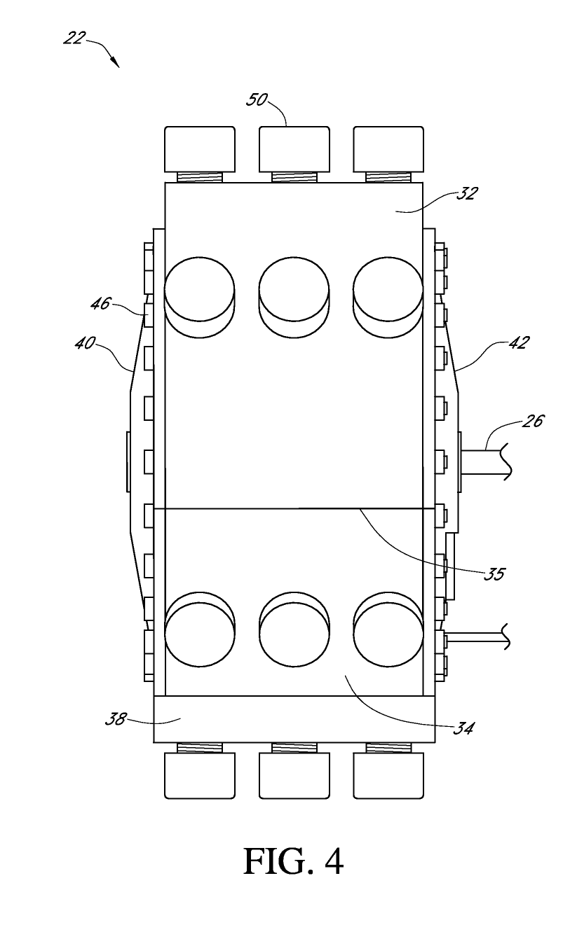

Referring to FIGS. 2-4, the flywheel motor assembly 22 is described in more detail. In an embodiment, the housing 36 of the flywheel motor assembly 22 is substantially cylindrical in shape and composed primarily of a top containment ring portion 32, a bottom containment ring portion 34, a base portion 38, and first and second end plates 40, 42. The housing 36 can be made from rigid materials with sufficient strength to withstand loads from standard operation of the flywheel motor assembly 22 as well as loads caused by operation and maneuver and of the vehicle. In an embodiment, aluminum alloy materials may be preferred because they are relatively inexpensive, lightweight, easily machined, with suitable strength and magnetic properties. It will be readily understood by those having ordinary skill in the Art that other materials may be used instead such as titanium or Inconel alloys, composites such as Kevlar or resin-impregnated carbon fiber, without departing from the spirit and scope of the present invention.

The top containment ring portion 32 and the bottom containment ring portion 34 connect with each other at the mating surface 35. When the top containment ring portion 32 and the bottom containment ring portion 34 contact each other along the mating surface 35, they are properly aligned in the shape of a tube or ring. It will be understood that other methods such as alignment pins or fasteners may be used instead of or in addition to the mating surface 35 to ensure that the top containment ring portion 32 and the bottom containment ring portion 34 are properly aligned. The top and bottom containment ring portions 32, 34 should be configured in such a way as to provide sufficient strength and durability to withstand and contain flywheel failure, such as flywheel rotor burst. In an embodiment, the top and bottom containment ring portions 32, 34 may be made of material with sufficient thickness to withstand such failures or they may be constructed with a safety layer on the outer surface of the containment ring portions 32, 34, such as Kevlar.

The base portion 38 of the housing 36 is integrally connected to the bottom containment ring portion 34 and serves as a mount structure such that the flywheel motor assembly 22 is mounted to the vehicle by fastening base portion 38 to the vehicle. While the preferred base portion 38 illustrated in FIGS. 2-4 is shown with a large, substantially flat bottom surface, the base portion may also be formed in shapes having significant contours to facilitate mounting to vehicles with non-planar or otherwise complex geometric mounting requirements. It should be understood that the base portion 38 need not be connected to the bottom containment ring portion 34. In an embodiment, the base portion 38 may instead be connected to the top containment ring portion 32 or the first or second end plates 40, 42. In this regard, the base portion 38 is capable of being configured in any number of ways so that the flywheel motor assembly 22 may be mounted to a given vehicle in the optimal location and orientation.

In an embodiment, the first and second end plates 40, 42 are substantially disc-shaped and are positioned opposite each other, one at either end of the tubular-shaped structure formed by the top containment ring portion 32 and the bottom containment ring portion 34. The first and second end plates 40, 42 are fixedly connected to the top and bottom containment ring portions 32, 34 by a plurality of carriage bolts 46, which may extend through the first end plate 40 across the housing 36 to the second end plate 42. Since at least some of the carriage bolts 46 pass through the top or bottom containment ring portions 32, 34, the carriage bolts also serve to help keep the top and bottom containment portions 32, 34 properly aligned. While carriage bolts 46 are preferable for securing the first and second end plates 40, 42, it should be understood that screws, rivets, or any other fastening method known to those having ordinary skill in the Art may also be used without departing from the spirit and scope of the present invention.

In an embodiment, at least one of the first or second end plates 40, 42 is configured to have an aperture positioned at or near the center of the end plate 42, through which the driveshaft 26 may pass. The aperture in the end plate 42 may be configured to include an airtight seal such that ambient air from outside the housing 36 may not enter the housing 36. It will be readily understood by a person having ordinary skill in the Art that having the aforementioned airtight seal will facilitate drawing a vacuum or utilizing other low-density gases inside the housing in order to reduce friction losses commonly associated with flywheels. Furthermore, it should be understood that other joints along the exterior of the housing 36, such as the mating surface 35 and the circumferential edges of the first and second end plates 40, 42, may also include seals for this purpose. The aforementioned seals may be of any type commonly known to those of ordinary skill in the Art such as lip seals, gaskets, O-rings or the like. While the illustrated embodiment is shown as having the driveshaft 26 protrude from only the second end plate 42, it should be known that the driveshaft 26 may also protrude from the first end plate 40. Having the driveshaft protrude from both ends of the flywheel motor assembly 22 may have other advantages. For example, the end of the driveshaft 26 protruding from the second end plate 42 may be connected to the drive wheels of the vehicle while the other end of the driveshaft 26 protruding from the first end plate 40 may be connected to other vehicle subsystems, such as a generator or a pump. Alternatively, the end of the driveshaft 26 protruding from the first end plate 42 may be coupled with a second flywheel motor assembly (not shown) in order to create a “stack”. Any number of flywheel motor assemblies may be stacked or aligned in this way for increased power output capability. The first and second end plates 40, 42 may also be penetrated by a first lead tube 82 and a second lead tube 86, respectively.

In an embodiment, the flywheel rotor also includes several electromagnet assemblies 50 arranged radially along the exterior of the housing 36, as part of a system that utilizes electromagnetic (EM) force to drive the rotation of the flywheel rotors. In an embodiment, there are six electromagnet assemblies 50 per flywheel rotor 54, 62, 70, which are evenly spaced around and integrated within the exterior of the housing 36. Accordingly, there are electromagnet assemblies 50 located approximately every sixty degrees around the housing 36 per flywheel. In an embodiment, there are three sets of six electromagnet assemblies 50 for a total of eighteen electromagnet assemblies 50 on the flywheel motor assembly 22. It will be understood that there may instead be any number of electromagnet assemblies 50 spaced uniformly around each rotor (e.g., as arranged in a typical multi-phase BLDC motor). Although the illustrated embodiment is described herein as having an EM drive system, it should be apparent to one skilled in the Art that the flywheel motor assembly 22 may instead utilize any other system for driving the rotation of the flywheel rotors such as a liquid jet system, a pneumatic system or the like.

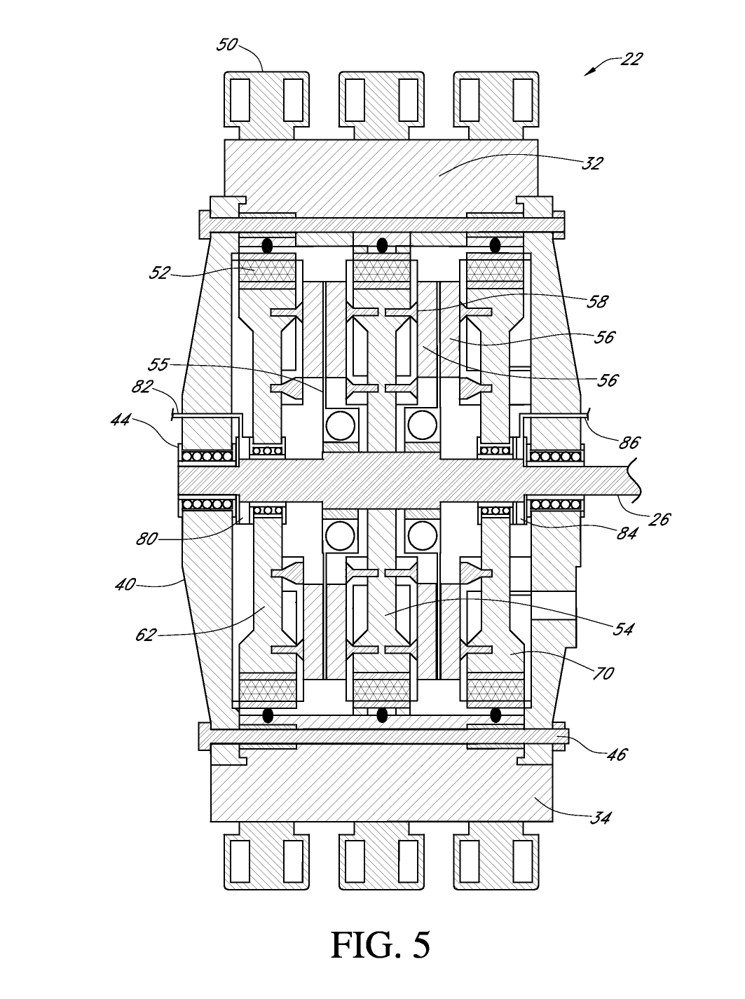

Referring now to FIG. 5, a planar cutaway view of a multi-stage flywheel motor assembly 22 is depicted. In an embodiment, the primary flywheel rotor 54, secondary flywheel rotor 62, and tertiary flywheel rotor 70 may each be substantially disc-shaped and radially symmetric. A person having ordinary skill in the Art will readily recognize that the flywheel rotors 54, 62, 70 may be machined as one piece from billet material or constructed from several pieces such as a hub-spoke-rim configuration, for instance. Moreover, the flywheel rotors may be constructed from any material with suitable mechanical strength and fatigue properties such as steel, aluminum, titanium, Inconel, carbon fiber composites and the like. The flywheel rotors 54, 62, 70 may be preferably constructed to have the same or similar diameters in order to facilitate frictional coupling to each other. However, the mass and/or moment of inertia of each flywheel rotor 54, 62, 70 may vary significantly from one another and each flywheel rotor 54, 62, 70 may be made of different materials or may in the manner they are constructed. The primary, secondary and tertiary rotors 54, 62, 70 are aligned coaxially and each is connected to the driveshaft 26.

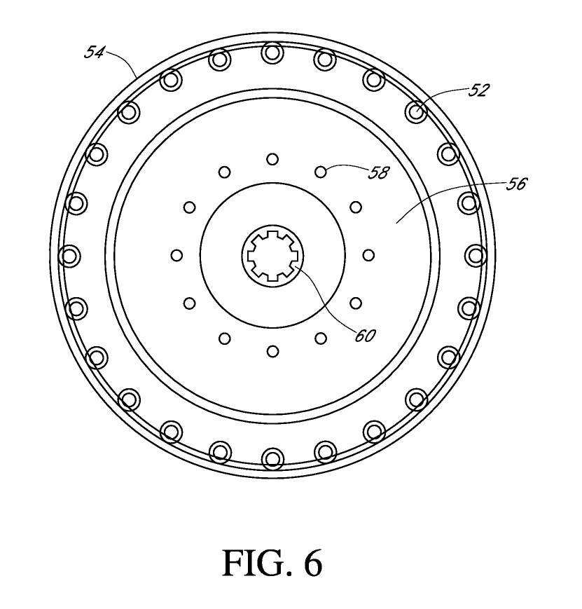

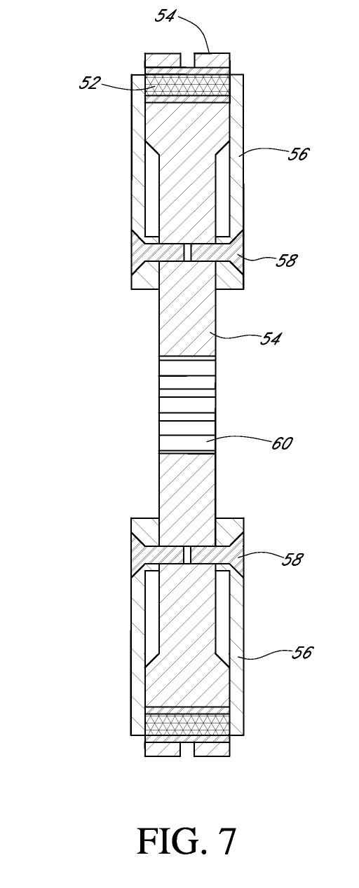

The primary flywheel rotor 54, depicted in FIGS. 5-7, is coupled with at least two pressure plates 56, one or more pressure plates being mounted on either side of the primary flywheel rotor 54. In an embodiment, the pressure plates 56 may be coupled to the flywheel rotor 54 by screw fasteners 58, however, it should be understood that they may also be coupled by any other commonly known fastening method, such as bolts, welding, bonding, an adhesive or the like. The pressure plate 56 provides a flat surface perpendicular to the driveshaft 26 in order to facilitate frictional engagement of the flywheel rotors 54, 62, 70. The pressure plate 56 distributes the forces acting on the primary flywheel rotor 54 when it frictionally engages one of the other flywheel rotors 62, 70. Additionally, the pressure plates 56 insulate the primary flywheel rotor 54 from excessive heat generated by the frictional engagement with the other flywheel rotors 62, 70 and their respective pressure plates 56. Protecting the primary flywheel rotor 54 from excessive heat serves to prevent warping and prevent a reduction in structural capabilities of the primary flywheel rotor 54. Therefore, the pressure plates 56 serve to extend the useful life of the flywheel rotors 54, 62, 70 and it is contemplated that the pressure plates 56 may be replaced one or more times during their useful lives.

In an embodiment, the primary flywheel rotor 54 is fixedly connected to the driveshaft 26 via a spline gear 60. In other words, the primary flywheel rotor 54 is rigidly affixed to the driveshaft 26, such that the primary flywheel rotor 54 and the driveshaft 26 rotate in unison about the same axis during operation. While a spline gear is preferred, it should be understood that the primary flywheel rotor 54 may alternately be connected to the driveshaft 26 by a weld or some other coupling means, without departing from the spirit and scope of the present invention.

The primary flywheel rotor 54 may be adapted to include one or more permanent magnets assemblies 52 attached along or near the circumference of the primary flywheel rotor 54. The permanent magnet assemblies 52 may be evenly spaced along the perimeter of the flywheel rotor 54 such that the permanent magnet assemblies 52 are in close proximity to corresponding electromagnet assemblies 50. As would be understood by those skilled in the Art (e.g., those familiar with BLDC motor function) the electromagnet assemblies 50 may be configured in such a way as to provide an isolated (per flywheel) drive force to the circumferentially positioned permanent magnet assemblies 52.

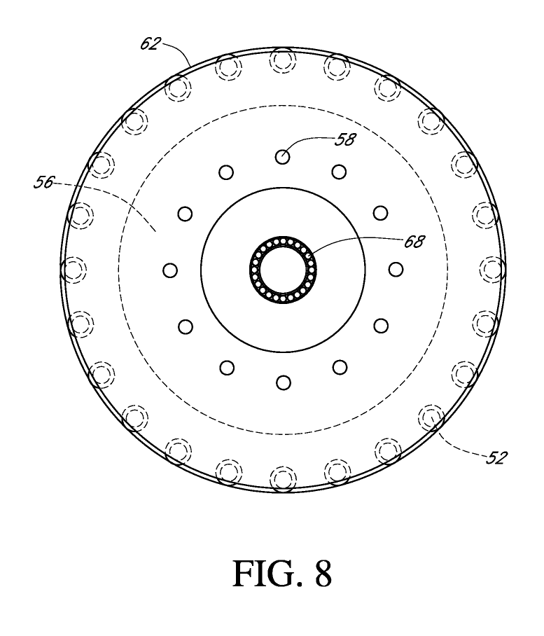

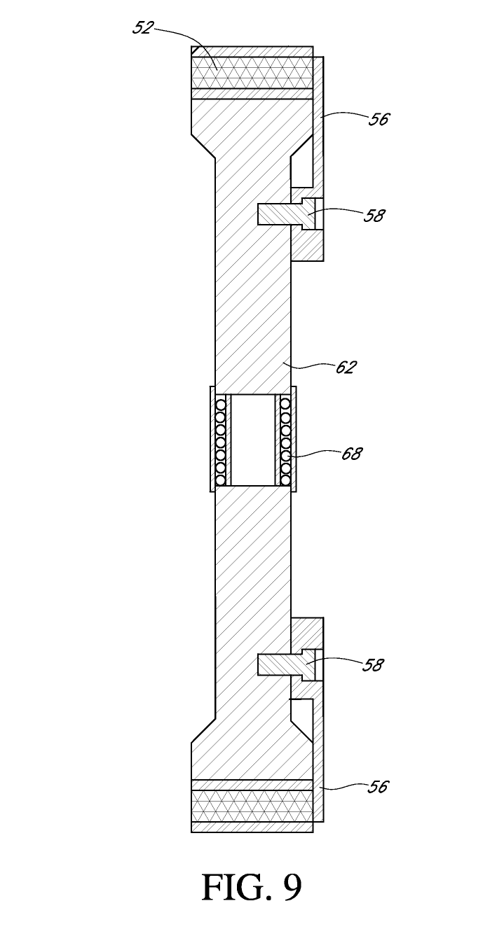

In an embodiment, the secondary and tertiary flywheel rotors 62, 70 are each coupled with a single pressure plate 56 on the side of the secondary or tertiary flywheel rotor 62, 70 facing to the primary flywheel rotor 54. In other words, the pressure plates 56 of the secondary and tertiary flywheel rotors 62, 70 are positioned to positionally oppose the pressure plates 56 connected to the primary flywheel rotor 54. In an embodiment, the secondary and tertiary flywheel rotors 62, 70 may be identical parts. As such, only the secondary flywheel rotor 62 is shown in FIGS. 8-9. However, it will be understood that the secondary and tertiary flywheel rotors 62, 70 need not be identical parts and may vary in geometry, mass, moment of inertia and material, for instance. The secondary and tertiary flywheel rotors 62, 70 may be constructed by any of the methods discussed previously with regard to the primary flywheel rotor 54. The pressure plates 56 may be attached to the secondary and tertiary flywheel rotors 62, 70 in the same way the pressure plates 56 are connected to the primary flywheel rotor 54.

In an embodiment, the secondary and tertiary flywheel rotors 62, 70 are rotatably connected to the driveshaft 26 via a bearing or set of bearings. In other words, the secondary and tertiary flywheel rotors 62, 70 are coupled with the driveshaft 26 such that the secondary and tertiary flywheel rotors 62, 70 and the driveshaft 26 all rotate independently about the same axis. While a ball bearing 68 is the depicted method of rotatably coupling the secondary and tertiary flywheel rotors 62, 70 to the driveshaft 26, other methods known to a person having ordinary skill in the Art may also be used, such as magnetic levitation bearings.

The secondary and tertiary flywheel rotors 62, 70 each preferably include one or more permanent magnet assemblies 52 along or near their circumferences. As with the primary flywheel rotor 54, the permanent magnet assemblies 52 associated with the secondary and tertiary flywheel rotors 62, 70 are evenly spaced along the perimeter of the flywheel rotors 62, 70 such that the permanent magnet assemblies 52 are in close proximity to corresponding electromagnet assemblies 50.

Referring again to FIG. 5, two friction discs 55 are shown. The friction discs are rotatably connected to the driveshaft 26 via a bearing or the like, such that the friction discs 55 and the driveshaft 26 all rotate independently about the same axis. The friction disc 55 is a thin, disc-shaped part made from a material with sufficient mechanical and thermal properties to withstand high shear forces and high temperatures due to friction. One friction disc 55 is positioned between the primary and secondary flywheel rotors 54, 62 and the other friction disc 55 is positioned between the primary and tertiary flywheel rotors 54, 70. As such, the primary purpose of the friction disc is to act as a conduit for shear and normal forces between the flywheel rotors 54, 62, 70. Alternatively, the friction disc 55 need not be present and opposing pressure plates 56 can make direct contact with each other without the friction disc 55 acting as an intermediary.

First and second thrust mechanisms 80, 84, (also referred to herein as first and second pressure chambers or first and second expandable seals), are also shown. The first thrust mechanism 80 is positioned between the first end plate 40 and the secondary flywheel rotor 62. The second thrust mechanism 84 is positioned between the second end plate 42 and the tertiary flywheel rotor 70. The first and second thrust mechanisms 80, 84 are preferably donut-shaped hollow cavities that are concentric with the driveshaft. The cavities within the first and second thrust mechanisms 80, 84 may be filled with any pressurized or ambient-pressure fluids known to a person having ordinary skill in the Art. For instance, the first and second thrust mechanisms 80, 84 may contain air, hydraulic fluid or the like. The first and second thrust mechanisms 80, 84 may be made of any material with sufficient mechanical properties and rigidity to contain said pressurized or ambient-pressure fluids.

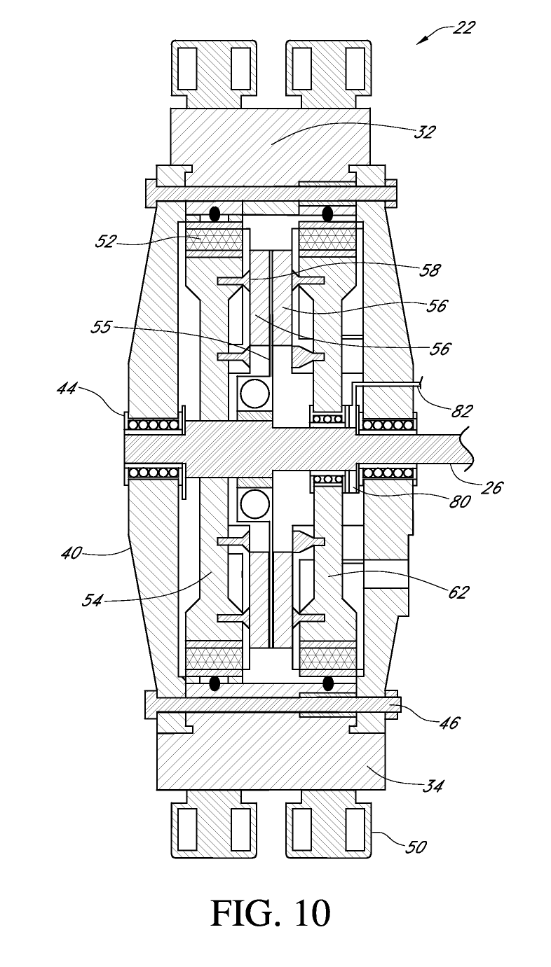

Referring now to FIG. 10, an embodiment of the present invention is illustrated having only two flywheel rotors: a primary flywheel rotor 54 and a secondary flywheel rotor 62. This configuration requires only one thrust mechanism 80 and lead tube 82. Moreover, the primary flywheel rotor 54 requires only one pressure plate 56 in the dual-rotor configuration. Having two rotors rather than three requires less space and fewer moving parts, which may be an ideal solution in situations where space is limited, for instance. It should be understood that the flywheel motor 22 of FIG. 10 is identical in component design and function as the flywheel motor 22 of FIG. 5.

In operation, the flywheel motor assembly 22 may start at rest until electrical energy is transferred from the power source 30 to the flywheel motor assembly 22 via the controller 28. The flywheel motor assembly 22 then uses the energy from the power source 30 to power the electromagnet assemblies 50 associated with the primary flywheel rotor 54. Once powered, the electromagnet assemblies 50 associated with the primary flywheel rotor 54 apply a force to the permanent magnet assemblies 52 attached to the primary flywheel rotor 54. The net force applied to the permanent magnet assemblies 52 is tangential to the primary flywheel, which causes the primary flywheel rotor 54 and the driveshaft 26 to accelerate, thereby gaining angular velocity and rotational energy.

If the rotational energy of the primary flywheel rotor 54 and the driveshaft 26 is not sufficient for purposes of powering the vehicle, additional energy may be sent from the power source 30 to the flywheel motor assembly 22 in order to power the electromagnet assemblies 50 associated with the secondary flywheel rotor 62. Once powered, the electromagnet assemblies 50 associated with the secondary flywheel rotor 62 apply a force to the permanent magnet assemblies 52 attached to the secondary flywheel rotor 62. The net force applied to the permanent magnet assemblies 52 is tangential to the secondary flywheel, which causes the secondary flywheel rotor 62 to accelerate in the same manner as previously described with regard to the primary flywheel rotor 54 and the driveshaft 26. Once the secondary flywheel rotor 62 has been accelerated to substantially the same rotational velocity as the primary flywheel rotor 54 and the driveshaft 26, the first thrust mechanism 80 is activated. The first thrust mechanism 80 forces the secondary flywheel rotor 62 toward the primary flywheel rotor 54 until the friction disc 55 between the two is clamped between the two opposing pressure plates 56, thereby frictionally engaging the secondary flywheel rotor 62 with the primary flywheel rotor 54.

If the rotational energy of the secondary flywheel rotor 62, the primary flywheel rotor 54 and the driveshaft 26 is not sufficient for purposes of powering the vehicle, additional energy may be sent from the power source 30 to the flywheel motor assembly 22 in order to power the electromagnet assemblies 50 associated with the tertiary flywheel rotor 70. Once powered, the electromagnet assemblies 50 associated with the tertiary flywheel rotor 70 apply a force to the permanent magnet assemblies 52 attached to the tertiary flywheel rotor 70. The net force applied to the permanent magnet assemblies 52 is tangential to the tertiary flywheel rotor 70, which causes the tertiary flywheel rotor 62 to accelerate in the same manner as previously described with regard to the secondary flywheel rotor 62, the primary flywheel rotor 54 and the driveshaft 26. Once the tertiary flywheel rotor 70 has been accelerated to substantially the same rotational velocity as the secondary flywheel rotor 62, the primary flywheel rotor 54 and the driveshaft 26, the second thrust mechanism 80 is activated. The second thrust mechanism 80 forces the tertiary flywheel rotor 70 toward the primary flywheel rotor 54 until the friction disc 55 between the two is clamped between the two opposing pressure plates 56, thereby frictionally engaging the tertiary flywheel rotor 70 with the primary flywheel rotor 54.

While the above description sets forth a particular order of operations in accelerating the three flywheel rotors 54, 62, 70 up to speed, it is contemplated that the flywheel rotors 54, 62, 70 may instead be brought up to speed in any other order, simultaneously, or that some of the flywheel rotors 54, 62, 70 may remain at rest. Once at least one of the flywheel rotors 54, 62, 70 reaches a desired angular velocity and rotational energy, rotational energy is removed from the flywheel motor assembly 22 by applying a torque to the driveshaft such as resistance from drive wheels or a generator, for example.

While several embodiments of the present invention have been illustrated and described herein, many changes can be made without departing from the spirit and scope of the invention. Accordingly, the scope of the invention is not limited by any disclosed embodiment. Instead, the scope of the invention should be determined from the appended claims that follow.

The embodiments of the present disclosure in which an exclusive property or privilege is claimed are defined as follows:

1. A method of storing energy in a multi-rotor flywheel system, comprising:
adding rotational energy to a primary rotor that is affixed to a driveshaft by applying a tangential force to the primary rotor;
adding rotational energy to a secondary rotor that is rotatably coupled to the driveshaft by applying a tangential force to the secondary rotor; and
activating a first thrust mechanism to frictionally engage the secondary rotor with the primary rotor such that the primary and secondary rotors couple to increase the moment of inertia applied to the driveshaft.

2. The method of claim 1, further comprising:
adding rotational energy to a tertiary rotor that is rotatably coupled to the driveshaft by applying a tangential force to the tertiary rotor; and
activating a second thrust mechanism to frictionally engage the tertiary rotor with the primary rotor such that the primary, secondary, and tertiary rotors couple to increase the moment of inertia applied to the driveshaft.

3. The method of claim 2, further comprising:
removing rotational energy from the primary, secondary, and tertiary rotors by applying a torque to the driveshaft.

4. The method of claim 2, wherein the tangential forces applied to the primary, secondary, and tertiary rotors emanate from a plurality of electromagnets configured to apply a repulsive magnetic force to permanent magnets of the primary, secondary, and tertiary rotors.

5. The method of claim 2, wherein the tangential forces applied to the primary, secondary, and tertiary rotors emanate from at least one fluid jet configured to drive turbine blades of the primary, secondary, and tertiary rotors.

6. The method of claim 2, wherein the primary, secondary, and tertiary rotors have substantially the same diameter but different moment of inertias.

7. The method of claim 2, wherein the primary, secondary, and tertiary rotors have substantially the same diameter and moment of inertias.

8. A flywheel motor configured to have a variable moment of inertia, the flywheel motor comprising:
a housing assembly;
a plurality of flywheels, each flywheel adapted to be driven by at least one tangential force;
a plurality of pressure plates affixed to exterior portions of the plurality of flywheels;
a crankshaft connected to a primary flywheel;
a secondary flywheel movably paired to the crankshaft with a first bearing; and
a first pressure chamber adapted to frictionally couple the primary and secondary flywheels by engaging at least one pressure plate affixed to the primary flywheel and at least one pressure plate affixed to the secondary flywheel with a first intermediary friction disc.

9. The flywheel motor of claim 8, wherein the plurality of flywheels each comprise at least one permanent magnet, and the housing assembly is coupled to a stator assembly that is configured to drive the flywheel with an electromagnetic tangential force.

10. The flywheel motor of claim 8, wherein the housing assembly is coupled to a fluid jet assembly that is configured to drive the flywheel with a tangential fluid force.

11. The flywheel motor of claim 8, further comprising:
a tertiary flywheel movably paired to the crankshaft with a second bearing; and
a second pressure chamber adapted to frictionally couple the primary and tertiary flywheels by engaging at least one pressure plate affixed to the primary flywheel and at least one pressure plate affixed to the secondary flywheel with a second intermediary friction disc.

12. The flywheel motor of claim 11, wherein the primary, secondary, and tertiary flywheels have substantially the same diameter but different moment of inertias.

13. The flywheel motor of claim 11, wherein the primary, secondary, and tertiary flywheels have substantially the same diameter and moment of inertias.

14. A multi-rotor flywheel energy storage system for vehicles, comprising:
a primary flywheel assembly with a means for applying a tangential force to a primary rotor;
a secondary flywheel assembly with a means for applying a tangential force to a secondary rotor;
a tertiary flywheel assembly with a means for applying a tangential force to a tertiary rotor;
a driveshaft that is fixedly coupled to the primary rotor and rotatably coupled to the secondary and tertiary rotors;
a first thrust mechanism configured to frictionally engage the secondary rotor with the primary rotor when the first thrust mechanism is activated or to frictionally disengage the secondary rotor from the primary rotor when the first thrust mechanism is deactivated; and
a second thrust mechanism configured to frictionally engage the tertiary rotor with the primary rotor when the second thrust mechanism is activated or to frictionally disengage the tertiary rotor from the primary rotor when the second thrust mechanism is deactivated.

15. The multi-rotor flywheel energy storage system of claim 14, further comprising:
a base portion;
a top containment ring portion;
a bottom containment ring portion; and
first and second end plates configured to rotatably engage the driveshaft.

16. The multi-rotor flywheel energy storage system of claim 14, wherein the secondary rotor and the tertiary rotor frictionally engage with the primary rotor with a plurality of pressure plates and at least one friction disc.

17. The multi-rotor flywheel energy storage system of claim 14, wherein the means for applying tangential force to the primary, secondary, and tertiary rotors is a plurality of electromagnets configured to apply a repulsive magnetic force to permanent magnets of the primary, secondary, and tertiary rotors.

18. The multi-rotor flywheel energy storage system of claim 14, wherein the means for applying tangential force to the primary, secondary, tertiary rotors is at least one fluid jet configured to drive turbine blades of the primary, secondary, and tertiary rotors.

19. The multi-rotor flywheel energy storage system of claim 14, wherein the primary, secondary, and tertiary rotors have substantially the same diameter but different moment of inertias.

20. The multi-rotor flywheel energy storage system of claim 14, wherein the primary, secondary, and tertiary rotors have substantially the same diameter and moment of inertias.
